(19) United States
(12) Patent Application Publication
(10) Pub. No.: US 2019/0375391 A1
(43) Pub. Date: Dec. 12, 2019

(54) BRAKE SYSTEM FOR A MOTOR VEHICLE

(71) Applicant: AUDI AG, Ingolstadt (DE)

(72) Inventor: Herbert ERNST, Ingolstadt (DE)

(73) Assignee: AUDI AG, Ingolstadt (DE)

(21) Appl. No.: 16/488,315

(22) PCT Filed: Feb. 21, 2018
(86) PCT No.: PCT/EP2018/054231

§ 371 Date: Aug. 23, 2019

(30) Foreign Application Priority Data
Mar. 28, 2017 (DE) 10 2017 205 257.0

(51) Int. Cl. B60T 13/74; B60T 7/04

(52) U.S. Cl. CPC B60T 13/745; B60T 8/4081; B60T 7/042

(57) ABSTRACT

A brake system for a motor vehicle, including at least one wheel brake which can be actuated by a pressure build-up in a brake line on the wheel brake side, a brake pedal, a sensor for detecting actuation information relating to actuation of the brake pedal, a brake actuator for generating a brake pressure in a brake actuator-side brake line, and a controller by which, in a first operating mode of the brake system, the brake actuator is controlled as a function of the actuation information, at least in the first operating mode, the brake line on the wheel brake side being fluidly coupled to the brake line on the brake actuator side.

The invention relates to a brake system for a motor vehicle, comprising at least one wheel brake which can be actuated by a pressure build-up in a brake line on the wheel brake side, a brake pedal, a sensor for detecting actuation information relating to actuation of the brake pedal, a brake actuator for generating a brake pressure in a brake line on the brake actuator-side and a controller, by which, in a first operating mode of the brake system, the brake actuator is controlled as a function of the actuation information, the brake line on the wheel brake side being having a fluid connection to the brake line on the brake actuator side at least in the first operating mode, the brake system having a brake cylinder in which a brake pressure can be built up by means of a brake piston mechanically coupled to the brake pedal. In addition, the invention relates to a motor vehicle.

Brake systems in motor vehicles should be highly robust, which is why typical requirements specify a redundant design of at least parts of the brake system. In addition, electronic controllability of the brake system is often desired, for example to implement a single-wheel brake for lane stabilization or a wheel-specific anti-lock brake system.

One option to meet these requirements is to detect a brake actuation via sensor and to perform the actual hydraulic braking movement by an actuator which is controlled in dependence on this recorded data. Such a procedure is known, for example, from publication DE 10 2011 114 805 A1. In order to enable hydraulic braking as a fallback level, a master brake cylinder is configured such that it can be moved both electrically and hydraulically by means of a hydraulic coupling with a brake cylinder arranged on the pedal. In this regard, one disadvantage is that the construction of a corresponding master brake cylinder is very complex.

Integrated brake systems are known from the publications DE 10 2014 111 594 A1 and DE 10 2015 103 860 A1, in which the pressure build-up at the wheel brakes occurs through the interaction of a pedal-side brake cylinder and an actuator-driven brake cylinder. The disadvantage here is that the interaction between the pedal-side brake cylinder and the other components is complex. This increases the installation space required and the complexity of the brake system and therefore also the costs. If the integration of such a brake system into a motor vehicle is to possible at a reasonable cost, the components of the brake system, including the actuator and the brake cylinder assigned to the pedal, must ultimately be designed together as a prefabricated module. This significantly reduces the design options, especially with regard to the placement of the pedal mechanism in the vehicle.

The underlying object of the invention is therefore to indicate an improved brake system. The object according to the invention is solved by a brake system of the type mentioned above, in which the brake cylinder is coupled via a brake cylinder valve to the brake line on the wheel brake side, which is closed in the first operating mode and opened in a second operating mode of the brake system.

According to the invention, it is proposed to decouple the brake cylinder actuated by the pedal from the brake line on the wheel brake side by closing the brake cylinder valve in a first operating mode, which corresponds in particular to normal operation of the brake system. The pressure build-up by the brake actuator is therefore independent of the actual brake actuation. Haptic feedback on the pedal can, for example, be provided by a feedback device, as will be explained below. In the second operating mode, however, the brake cylinder is coupled to the brake line on the wheel brake side. In particular, this can provide a fallback level for the brake system which enables the wheel brakes to be actuated even if, for example, the sensor and/or brake actuator have failed.

This structure enables the fluidic, in particular hydraulic, coupling of the brake cylinder with the brake lines on the wheel brake side to be designed such that an optimum braking result is achieved in the second operating mode. As the brake cylinder is decoupled from the wheel brakes in the first operating mode, the first operating mode does not restrict the design of the brake cylinder, which can result in shorter actuation distances in the second operating mode, for example.

As will be explained in more detail later, the inventive design of the brake system is also particularly well suited to modularizing the brake system and, in particular, to structurally separate an assembly comprising the brake pedal and the driver-operated brake cylinder from a further assembly which may, for example, comprise the brake actuator, the brake cylinder valve and the controller. In addition to an electrical connection for reading out the sensor, in the case of a brake cylinder designed as a single cylinder, for example, only a single hydraulic line is required to connect these construction units. In addition, a second hydraulic line for fluidic coupling of the brake cylinder with a compensation reservoir for the brake fluid is preferably provided. If separate brake circuits are also provided on the brake cylinder, for example by the brake cylinder being designed as a tandem main brake cylinder, one hydraulic line per brake circuit is typically sufficient, preferably with at least one supplementary supply line being provided for connection to the compensation reservoir.

In particular, the brake cylinder valve may be normally open. In this case, for example, a changeover to the second operating mode takes place automatically in the event of a failure of the control unit. The brake lines can, for example, be hydraulic or pneumatic lines and carry a brake fluid. For example, the brake actuator can be designed such that a piston is moved in an actuator cylinder that is fluidically coupled to the brake line on the brake actuator side.

In the following explanations, it is largely assumed that a single cylinder is used as the brake cylinder. It is of course also possible to use the described procedure in cases where a second brake circuit is led to the brake cylinder. In this case, the brake cylinder can be designed as a main tandem cylinder, for example. The second brake circuit can be constructed according to the first brake circuit, i.e. the brake cylinder can be separated from the second brake circuit by means of another brake cylinder valve, for example. However, any other formation of the second brake circuit is also possible.

The brake line on the wheel brake side can be coupled to the brake line on the brake actuator side via a brake actuator valve, which is open in the first operating mode and closed in the second operating mode. In the second operating mode, the brake actuator can therefore be decoupled from the wheel brakes. This ensures robust operation in the second operating mode even if leaks occur in the brake actuator area or if the brake actuator fails or malfunctions.

The brake system may have a feedback device by means of which a haptic feedback signal can be transmitted to the brake pedal in the first operating mode, wherein a pressure can be built up in a feedback line by means of the feedback device, which is fluidically coupled to the brake cylinder at least in the first operating mode. The brake cylinder can therefore be used in the first operating mode as an output device for issuing a haptic feedback signal. In this case, the feedback device can be provided at a distance from the brake cylinder, especially in an integrated brake system. This can further reduce the consumed installation space of a unit that includes the brake cylinder. In another embodiment of the invention, the feedback device may be located close to the brake cylinder in order to positively influence a haptic feedback effect on the brake pedal. The feedback device may be a feedback actuator or it may include a feedback actuator. The feedback actuator can be controlled by the control unit to give the feedback signal.

The brake cylinder can be coupled to the feedback line via a feedback valve, which is open in the first operating mode and closed in the second operating mode. In the second operating mode, feedback of braking forces by the feedback actuator is no longer necessary, as the brake cylinder is fluidly coupled to the brake line on the wheel brake side, so that braking forces can be haptically sensed directly by a driver. By decoupling the non-required feedback actuator, robust operation of the brake system is possible in the second operating mode even if the feedback device fails or malfunctions or if leaks occur in the area of the feedback device.

The brake system may comprise an integrated brake module and a pedal module formed separately therefrom, wherein the pedal module comprises the brake cylinder, the brake piston, the brake pedal and the sensor, and wherein the integrated brake module comprises the brake force actuator and the brake cylinder valve. The integrated brake module may in particular also include the controller and/or the brake actuator valve. The feedback device and/or the feedback valve can either be integrated in the pedal module or in the integrated brake module. By separating the components integrated in the integrated brake module from the pedal module, the pedal module takes up less space, which results in greater flexibility for the arrangement of the brake pedal or the entire pedal system in the vehicle.

Preferably, the integrated brake module also comprises a reservoir for a brake fluid and/or a valve block for the controllable coupling of the brake lines on the wheel brake side with the wheel brakes. The advantages of the compact design and the modular installation of an integrated brake module are therefore largely achieved, although the brake pedal can be positioned at a slight distance from the integrated brake module due to the invention-related design.

The pedal module can be coupled to the integrated brake module via a connecting line that fluidically couples the brake cylinder to a line section on the brake module side that is connected to the brake cylinder valve. The line section can also be coupled with the feedback valve and/or the brake actuator valve. If a single cylinder is used as the brake cylinder, the connecting line may be the only hydraulic connection between the pedal module and the brake module. If, for example, a master tandem brake cylinder is used as the brake cylinder, an additional connecting line can be provided for the second brake circuit.

The pedal module can also be coupled to the integrated brake module via a further connecting line, through which the brake cylinder on the brake module side can be fluidly coupled or can be coupled to a reservoir. If the reservoir is located on or in the brake module, the brake fluid quantity in the brake cylinder can be easily balanced via the additional connecting line.

The controller may be arranged to monitor at least one operating parameter of the braking system and to trigger a change of the brake system to the second operating mode if a fault condition dependent on the operating parameter is fulfilled, the fulfillment of which in particular indicates a malfunction of the brake system or at least one component of the brake system.

A pressure sensor can be provided on the brake line on the wheel brake side and/or on the brake actuator side and/or on the feedback line and/or on the line section, wherein the controller is arranged to trigger a change of the brake system to the second operating mode as a function of a pressure value detected by the pressure sensor. In particular, the controller can control the brake cylinder valve to open it. Optionally, the control unit can also control the brake actuator valve and/or the feedback valve to close them. In particular, a pressure on the input side, which is supplied by the brake cylinder, and a pressure on the output side, which is fed to the brake line on the wheel brake side, can be determined to switch over to the second operating mode. A pressure on the input side can, for example, be detected via a pressure sensor on the line section or on the feedback line. An output pressure can be detected on the brake actuator side or the brake line on wheel brake side.

The brake system may comprise several wheel brakes, several brake lines on the wheel brake side being connected to the brake cylinder valve and/or to the brake actuator valve and/or the brake system may comprise several brake cylinder valves and/or several brake actuator valves to each of which at least one brake line on the wheel brake side is connected. For example, the motor vehicle may comprise four wheel brakes and four brake lines on the wheel brake side may therefore be provided. Each of these brake lines can be routed to a separate brake actuator valve or brake cylinder valve or one brake cylinder valve or brake actuator valve can be used for several brake lines on the wheel brake side.

In addition to the invention-related brake system, the invention relates to a motor vehicle which incorporates an invention-related brake system.

Further advantages and details of the invention result from the following embodiments and the associated illustrations. These schematically show:

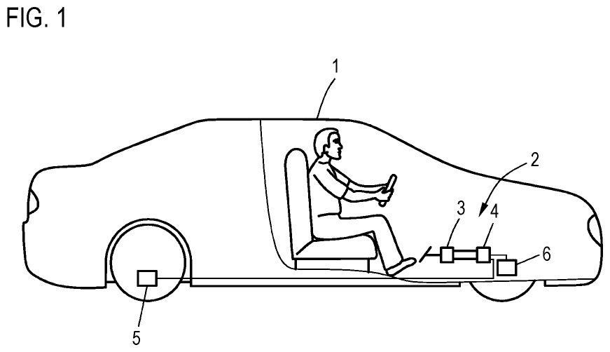

FIG. 1 an embodiment of an invention-related motor vehicle comprising an embodiment of the invention-related brake system, and

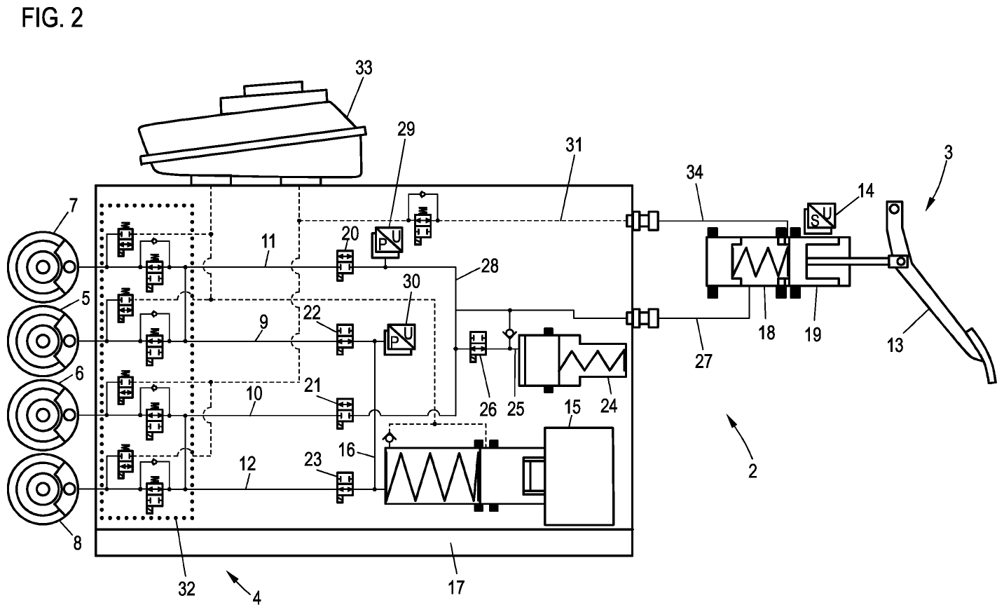

FIG. 2 a detailed view of the brake system shown in FIG. 1.

FIG. 1 shows a motor vehicle 1 comprising a brake system 2 comprising a pedal module 3, an integrated brake module 4 and a multiple wheel brakes 5-8, of which only the wheel brakes 5, 6 are shown in FIG. 1. The structure of the brake system 2 is shown in detail in FIG. 2. The brake system 2 comprises several wheel brakes 5-8, which can be actuated by pressure build-up in a respective brake line 9-12 on the wheel brake side. In addition, the brake system 2 comprises a brake pedal 13, a sensor 14 for detecting actuation information relating to actuation of the brake pedal 13, a brake actuator 15 for generating a brake pressure in a brake actuator-side brake line 16 and a controller 17 by means of which, in a first operating mode of the brake system 2, the brake actuator 15 is controlled as a function of the actuation information. In the first operating mode, the brake lines 9-12 on the wheel brake side are fluidically coupled with the brake line 16 on the brake actuator side. The brake system 2 therefore implements a brake-by-wire system in the first operating mode, in which pedal actuations are sensory detected and the brake actuator 15 is controlled in accordance with these detected pedal actuations in order to actuate the wheel brakes 5-8.

A purely hydraulic actuation path is provided in order to implement a fallback level that still enables reliable actuation of wheel brakes 5-8, even if, for example, sensor 14 or brake actuator 15 fail. For this the brake system 2 features a brake cylinder 18, in which a brake pressure can be built up by a brake piston 19 mechanically coupled with the brake pedal. In the following, it is initially assumed that the brake cylinder 18 is a single cylinder. The use of a master tandem brake cylinder and a second brake circuit will be discussed at a later stage.

The brake cylinder 18 is connected to the brake lines 9-12 on the wheel brake side via the brake cylinder valves 20, 21. The brake cylinder valves 20, 21 can be controlled by the controller 17. They are controlled such that they are closed in the first operating mode and therefore decouple the brake lines 9-12 on the wheel brake side from the brake cylinder. This implements a brake-by-wire system.

The brake cylinder valves 20, 21 are designed such that they have an open power supply in the event of an interruption. If, for example, controller 17 fails, brake system 2 automatically switches to the second operating mode, in which the brake cylinder 18 is fluidically connected to the brake lines 9-12 on the wheel brake side in order to implement a hydraulic actuation path from brake cylinder 18 to the wheel brakes 5-8, which enables brake actuation even without using the electronic components. In addition, the controller 17 can also specifically control valves 20 and 21 in order to switch to the second operating mode of brake system 2 if, as will be explained in detail at a later stage, certain basic conditions are met or certain faults are detected.

In the second operating mode, the brake lines 9-12 on the wheel brake side are decoupled from the brake actuator 15 and the brake line 16 on the brake actuator side. The two brake actuator valves 22, 23 are provided for this purpose, and can be closed by the controller 17 when switching to the second operating mode. The brake actuator valves are preferably designed such that they are normally closed.

To allow the brake pedal 13 to be actuated for a longer distance or to give a user haptic feedback when the pedal is actuated, brake system 2 has a feedback device 24. For this purpose, a pressure can be built up in a feedback line 25 by means of the feedback device, which in the first operating mode is coupled to the brake cylinder 18 via the feedback valve 26. The feedback device 24 is shown as a spring-loaded piston in FIG. 2. In addition or alternatively, it would be possible for the feedback device 24 to have a feedback actuator in order to enable specific pressure build-up on the brake cylinder in the first operating mode. The feedback actuator can be controlled by the controller 17.

The feedback valve 26 can be closed by the controller 17 when switching to the second operating mode in order to decouple the feedback unit from the brake cylinder 18. The feedback valve is preferably designed such that it is normally closed in order to decouple the feedback device from the brake cylinder 18. On the one hand, this enables robust operation of the brake system in the second operating mode even in the event of a malfunction of the feedback device 24 in the second operating mode and, on the other hand, prevents an extension of the actuation paths of the brake pedal 13 by yielding to the feedback device in this operating mode.

In order to detect possible faults in the brake system 2 which should lead to a change to the second operating mode, the controller 17 records at least one operating parameter of the brake system. If a fault condition dependent on the operating parameter is fulfilled, the fulfillment of which fault condition indicates in particular a malfunction of the brake system 2 or at least one component of the brake system 2, the controller 17 triggers a change of the brake system to the second operating mode. For example, the controller 17 can detect pressure values in different lines of the brake system 2 via two pressure sensors 29, 30. In the first operating mode, the pressure sensor 29 arranged on the line section 28 detects a pressure which is determined by the pressure in the pressure cylinder 19 and the feedback device 24, i.e. an input pressure which correlates with the pedal position of the brake pedal 13 when the brake system is functioning correctly. In the first operating mode, the pressure sensor 30 records the pressure provided by the brake actuator 15 to the brake lines 9-12 on the wheel brake side, i.e. an output pressure of the brake system 2. With correct control and function of the brake actuator 15, this should be in a defined relationship with the pressure measured by the pressure sensor 29 at input. If the measured pressures deviate from this limit value by more than a specified amount, the controller 17 can trigger a change to the second operating mode.

As shown in FIG. 2, the various components of the brake system are divided into two modules. The pedal module 3 comprises the brake cylinder 18, the brake piston 19, the brake pedal 13 and the sensor 14. The other components of the brake system 2, apart from the wheel brakes 5, 6, 7, 8 and the connecting lines leading to them, are integrated in an integrated brake module 4. Alternatively, the feedback device 24 and/or the feedback valve 26 could also be arranged in the pedal module 3. On the one hand, the division of the components into two modules makes it relatively easy to integrate the brake system into the motor vehicle 1. On the other hand, only a relatively small installation space is required in the immediate vicinity of the brake pedal 13, since the components integrated in the integrated brake module 4 can be arranged at a distance from the brake pedal 13. If a single cylinder is used as brake cylinder 18, a single hydraulic connecting line 27 is sufficient to connect the pedal module 3 with the integrated brake module 4. In addition, an electrical connection cable not shown can be provided for transmitting the sensor signals of the sensor 14. In addition, a second hydraulic line 34 is provided for fluidically coupling the brake cylinder 18 with the reservoir 33. The lines 31 for fluid exchange between brake circuit and reservoir 33 are dashed in FIG. 2.

In addition, a second brake circuit could be provided. This allows an additional fallback level to be provided for the hydraulic brake system. Corresponding second brake circuits are known in the art, which is why the design of this second brake circuit need not be explained in detail. A change between the first and second brake circuit can follow via the valve block 32, which is also used for coupling with the reservoir 33. This valve block can be used, for example, to achieve a different braking behavior of individual wheels as part of a lane departure warning system or an anti-lock brake system.

A reservoir 33 for brake fluid is preferably provided on the integrated brake module 4 in order, for example, to compensate for a temperature expansion of brake fluid or over time or minor losses of brake fluid.

1-11. (canceled)

12. A brake system for a motor vehicle, comprising at least one wheel brake which can be actuated by a pressure build-up in a brake line on the wheel brake side, a brake pedal, a sensor for detecting actuation information relating to actuation of the brake pedal, a brake actuator for generating a brake pressure in a brake line on the brake actuator side, and a controller, by which, in a first operating mode of the brake system, the brake actuator is controlled as a function of the actuation information, the brake line on the wheel brake side being fluidically coupled to the brake line on the brake actuator side at least in the first operating mode, the brake system having a brake cylinder in which a brake pressure can be built up by means of a brake piston mechanically coupled to the brake pedal, wherein the brake cylinder is coupled via a brake cylinder valve to the wheel brake-side brake line which is closed in the first operating mode and opened in a second operating mode of the brake system.

13. The brake system according to claim 12, wherein the brake line on the wheel brake-side is coupled via a brake actuator valve to the brake line on the brake actuator-side which is open in the first operating mode and closed in the second operating mode.

14. The brake system according to claim 12, wherein the brake system has a feedback device by means of which a haptic feedback signal can be given on the brake pedal in the first operating mode, facilitating a pressure to be built up in a feedback line by the feedback device, which pressure is fluidically coupled to the brake cylinder at least in the first operating mode.

15. The brake system according to claim 14, wherein the brake cylinder is coupled via a feedback valve to the feedback line which is open in the first operating mode and closed in the second operating mode.

16. The brake system according to claim 12, wherein it comprises an integrated brake module and a pedal module formed separately therefrom, the pedal module comprising the brake cylinder, the brake piston, the brake pedal and the sensor, and the integrated brake module comprising the brake force actuator and the brake cylinder valve.

17. The brake system according to claim 16, wherein the integrated brake module additionally comprises a reservoir for a brake fluid and/or a valve block for controllably coupling the brake lines on the wheel brake side to the wheel brakes.

18. The brake system according to claim 16, wherein the pedal module is coupled to the integrated brake module via a connecting line which fluidically couples the brake cylinder to a line section on the brake module side which is connected to the brake cylinder valve.

19. The brake system according to claim 18, wherein the pedal module is additionally coupled to the integrated brake module via a further connecting line, by means of which the brake cylinder is fluidically coupled or can be coupled on the brake module side to a reservoir.

20. The brake system according to claim 12, wherein the controller is set up to monitor at least one operating parameter of the brake system and to trigger a change of the brake system to the second operating mode if a fault condition dependent on the operating parameter is fulfilled.

21. The brake system according to claim 12, wherein it comprises multiple wheel brakes, wherein multiple brake lines on the wheel brake side are connected to the brake cylinder valve and/or to the brake actuator valve and/or wherein the brake system comprises multiple brake cylinder valves and/or multiple brake actuator valves, to each of which at least one brake line on the wheel brake side is connected.

22. The brake system according to claim 13, wherein the brake system has a feedback device by means of which a haptic feedback signal can be given on the brake pedal in the first operating mode, facilitating a pressure to be built up in a feedback line by the feedback device, which pressure is fluidically coupled to the brake cylinder at least in the first operating mode.

23. The brake system according to claim 13, wherein it comprises an integrated brake module and a pedal module formed separately therefrom, the pedal module comprising the brake cylinder, the brake piston, the brake pedal and the sensor, and the integrated brake module comprising the brake force actuator and the brake cylinder valve.

24. The brake system according to claim 14, wherein it comprises an integrated brake module and a pedal module formed separately therefrom, the pedal module comprising the brake cylinder, the brake piston, the brake pedal and the sensor, and the integrated brake module comprising the brake force actuator and the brake cylinder valve.

25. The brake system according to claim 15, wherein it comprises an integrated brake module and a pedal module formed separately therefrom, the pedal module comprising the brake cylinder, the brake piston, the brake pedal and the sensor, and the integrated brake module comprising the brake force actuator and the brake cylinder valve.

26. The brake system according to claim 17, wherein the pedal module is coupled to the integrated brake module via a connecting line which fluidically couples the brake cylinder to a line section on the brake module side which is connected to the brake cylinder valve.

27. The brake system according to claim 13, wherein the controller is set up to monitor at least one operating parameter of the brake system and to trigger a change of the brake system to the second operating mode if a fault condition dependent on the operating parameter is fulfilled.

28. The brake system according to claim 14, wherein the controller is set up to monitor at least one operating parameter of the brake system and to trigger a change of the brake system to the second operating mode if a fault condition dependent on the operating parameter is fulfilled.

29. The brake system according to claim 15, wherein the controller is set up to monitor at least one operating parameter of the brake system and to trigger a change of the brake system to the second operating mode if a fault condition dependent on the operating parameter is fulfilled.

30. The brake system according to claim 16, wherein the controller is set up to monitor at least one operating parameter of the brake system and to trigger a change of the brake system to the second operating mode if a fault condition dependent on the operating parameter is fulfilled.

31. The brake system according to claim 17, wherein the controller is set up to monitor at least one operating parameter of the brake system and to trigger a change of the brake system to the second operating mode if a fault condition dependent on the operating parameter is fulfilled.
